(19) United States
(12) Patent Application Publication
(10) Pub. No.: US 2013/0001245 A1
(43) Pub. Date: Jan. 3, 2013

(54) PREVENTION OF LINER CHOKE-OFF IN LINER-BASED PRESSURE DISPENSATION SYSTEM

(75) Inventors: Michael A. Cisewski, Hutchinson, MN (US); Paul Dathe, Plymouth, MN (US); Donald D. Ware, Woodbury, MN (US); Amy Koland, Eden Prairie, MN (US)

(73) Assignee: ADVANCED TECHNOLOGY MATERIALS, INC., Danbury, CT (US)

(21) Appl. No.: 13/608,948

(22) Filed: Sep. 10, 2012

Related U.S. Application Data
(62) Division of application No. 12/525,128, filed on Aug. 21, 2009.
(60) Provisional application No. 60/887,194, filed on Jan. 30, 2007.

(51) Int. Cl. B65D 35/28; F17D 1/00

(52) U.S. Cl. 222/1; 222/105; 222/95; 137/1

(57) ABSTRACT

To avoid problems associated with choke-off of a collapsible liner (e.g., disposed within a rigid overpack) during pressure dispensing of fluid therefrom, a pressure dispense package includes a choke prevention element comprising any of a perforated flange within the liner, a channel-defining flange within the liner, a film defining at least one liquid channel along an inner surface of the liner, a radial stiffening element coupled to the liner, an orifice-defining hollow internal support disposed within the liner, one or more magnetic and complementary magnetically responsive elements associated with the liner and surrounding container, or differential collapse characteristics between liner panels. Methods for preventing choke-off of a collapsible liner adapted for pressure dispensing are also provided.

### CROSS-REFERENCE TO RELATED APPLICATIONS

This application is a divisional of U.S. patent application Ser. No. 12/525,128 filed on Aug. 21, 2009, which is a U.S. national phase application under the provisions of 35 U.S.C. §371 of International Application No. PCT/US08/52506 filed on Jan. 30, 2008, which in turn claims priority of U.S. Provisional Patent Application No. 60/887,194 filed on Jan. 30, 2007. The disclosures of the foregoing applications are hereby incorporated by reference herein in their respective entireties, for all purposes.

### BACKGROUND OF THE INVENTION

1. Field of the Invention

This invention relates to dispensing systems, such as are utilized to effect supply of fluid materials for use thereof. In a specific aspect, the invention relates to pressure-dispensing systems, wherein liquid or other fluid material is discharged from a source vessel by displacement with a pressurized medium, e.g., air or liquid, and to associated aspects relating to fabrication, operational processes, and deployment of such systems.

2. Description of the Related Art

In many industrial applications, chemical reagents and compositions are required to be supplied in a high purity state, and specialized packaging has been developed to ensure that the supplied material is maintained in a pure and suitable form, throughout the package fill, storage, transport, and ultimate dispensing operations.

In the field of microelectronic device manufacturing, the need for suitable packaging is particularly compelling for a wide variety of liquids and liquid-containing compositions, since any contaminants in the packaged material, and/or any ingress of environmental contaminants to the contained material in the package, can adversely affect microelectronic device products that are manufactured with such liquids or liquid-containing compositions, rendering the microelectronic device products deficient or even useless for their intended use.

As a result of these considerations, many types of high-purity packaging have been developed for liquids and liquid-containing compositions used in microelectronic device manufacturing, such as photoresists, etchants, chemical vapor deposition reagents, solvents, wafer and tool cleaning formulations, chemical mechanical polishing compositions, etc.

One type of high-purity packaging that has come into such usage includes a rigid or semi-rigid overpack containing a liquid or liquid-based composition within a flexible liner or bag that is secured in position in the overpack by retaining structure such as a lid or cover. Such packaging is commonly referred to as “bag-in-can” (BIC), “bag-in-bottle” (BIB) and “bag-in-drum” (BID) packaging. In each instance, the overpack material is substantially more rigid than the liner contained within. The rigid or semi-rigid overpack of the packaging may for example be formed of a high-density polyethylene or other polymer or metal, and the liner may be provided as a pre-cleaned, sterile collapsible bag of a polymeric film material, such as polytetrafluoroethylene (PTFE), low-density polyethylene, PTFE-based multilaminates, polyurethane, or the like, selected to be inert to the contained liquid or liquid-based material to be contained in the liner. Packaging of such type is commercially available under the trademark NOWPAK from ATMI, Inc. (Danbury, Conn., USA).

In the dispensing operation involving such liner packaging of liquids and liquid-based compositions, liquid is dispensed from the liner by connecting a dispensing assembly including a dip tube, or short probe, to a port of the liner, with the dip tube being immersed in the contained liquid. After the dispensing assembly has been thus coupled to the liner, fluid, e.g., gas, pressure is applied on the exterior surface of the liner, so that it progressively collapses and forces liquid through the dispensing assembly for discharge to associated flow circuitry for flow to an end-use site.

A problem associated with dispensation of liquids from collapsible liner-based dispensation systems is premature choke-off, when a liner necks and ultimately collapses on itself or a structure internal to the liner to form a choke point disposed above a substantial amount of liquid disposed below such choke point. When it occurs, such premature choke-off precludes complete utilization of liquid disposed within the liner. Such problem is far from trivial, as specialty chemical reagents utilized in industrial processes such as the manufacture of microelectronic device products are extraordinarily expensive. It therefore is necessary from an economic perspective to achieve as complete a utilization of the liquid from a package as possible, so that no substantial residual amount of liquid remains in the package after the dispensing operation has been completed.

The art therefore continues to seek improvements in dispensing packages and systems.

### SUMMARY OF THE INVENTION

The present invention relates to dispensing systems, useful for supply of fluid materials to a tool, process, or location at or in which the fluid is utilized, and to components and assemblies useful in such dispensing systems, and associated methods for using such systems.

In aspect, the invention relates to a pressure dispense package comprising: a collapsible liner adapted to hold a fluid; and a choke prevention element comprising any of: (a) at least one perforated flange disposed within the liner, (b) at least one channel-defining flange disposed within the liner, (c) a film defining at least one liquid channel disposed along an internal surface of the liner, (d) a radial stiffening element coupled to the liner, (e) a hollow internal support disposed within and operatively coupled to a side wall of the liner, the hollow internal support having a first orifice disposed in a lower portion of the liner, and having a second orifice disposed in an upper portion of the liner, (f) at least one first magnetic or magnetically interactive material coupled to the liner, said at least one first magnetic or magnetically interactive material being adapted to interact with a corresponding at least one second magnetic or magnetically interactive material coupled to an overpack container surrounding the liner, and (g) a first panel of the liner having collapse characteristics differing from a second panel of the liner that is peripherally bonded to the first panel.

Methods for preventing choke-off of a collapsible liner adapted for pressure dispensing, including addition of a choke prevention element to said liner, are also provided. The space between such a liner and a surrounding overpack container may be pressurized, with the choke prevention element utilized to prevent liner choke-off during said fluid dispensation.

Other aspects, features and advantages of the invention will be more fully apparent from the ensuing disclosure and appended claims.

### BRIEF DESCRIPTION OF THE DRAWINGS

FIG. 1 is a schematic view of a process installation including a liner-based fluid storage and dispensing package arranged to provide a chemical reagent to a processing tool in a microelectronic device manufacturing facility, for the manufacture of a microelectronic product.

FIGS. 2A-2C are schematic side cross-sectional views of a collapsible liner disposed within an overpack container in three sequential operating states of pressure dispensation, with FIG. 2C illustrating the formation of an undesirable choke point intermediately disposed along the liner upon collapse of a portion of the liner against itself.

FIG. 3 is a schematic side cross-sectional view of a liner having a dip tube.

FIG. 4 is a schematic side cross-sectional view of a liner having internal flanges adapted to prevent intermediate liner collapse and a choke-off condition during pressure dispensation according to a specific embodiment of the present invention.

FIG. 5A is a schematic side cross-sectional view of a liner having a first external radial stiffening element adapted to prevent intermediate liner collapse and a choke-off condition during pressure dispensation according to a specific embodiment, the liner depicted in a first state of operation.

FIG. 5B is a schematic side cross-sectional view of the liner of FIG. 5A in a second state of operation (e.g., compressed) during pressure dispensation.

FIG. 6 is a schematic top cross-sectional view of a liner having an external partial radial stiffening element adapted to prevent intermediate liner collapse and a choke-off condition during pressure dispensation according to a specific embodiment.

FIG. 7 is a schematic top cross-sectional view of a liner having an internal hollow support element adapted to prevent intermediate liner collapse and a choke-off condition during pressure dispensation according to a specific embodiment.

FIG. 8A is a schematic side cross-sectional view of a liner comprising a film portion defining at least one liquid channel disposed along an internal surface of the liner and adapted to prevent intermediate liner collapse and a choke-off condition during pressure dispensation according to a specific embodiment.

FIG. 8B is an expanded schematic view of various channels formed in a surface of the film portion of FIG. 8A.

FIG. 9A is a schematic side cross-sectional view of a liner disposed within a container according to another specific embodiment, with the liner having choke prevention elements comprising magnetic or magnetically interactive elements arranged as rings, and the container having corresponding magnetic or magnetically interactive elements adapted to magnetically interact with the choke prevention elements.

FIG. 9B is a schematic side cross-sectional view of a liner disposed within a container according to another specific embodiment, with the liner having choke prevention elements comprising magnetic or magnetically interactive elements, and the container having corresponding magnetic or magnetically interactive elements adapted to magnetically interact with the choke prevention elements.

FIG. 10 is a cross-sectional view of a portion of a liner formed from a first multi-layer composite panel and a second multi-layer composite panel, with the first and second panels being peripherally bonded to one another.

FIG. 11A is a schematic front view of a liner formed from peripherally bonded first and second panels according to a specific embodiment, with the first panel having a first vertically oriented localized region that imparts the first panel with collapse characteristics differing from the second panel.

FIG. 11B is schematic cross-sectional view of the liner of FIG. 11A in partially collapsed condition, showing a gap remaining between the first panel and second panel due to the differing collapse characteristics of the first panel and the second panel.

FIG. 11C is a schematic front view of another liner formed from peripherally bonded first and second panels according to a specific embodiment, with the first panel having first and second vertically oriented localized regions that impart the first panel with collapse characteristics differing from the second panel.

FIG. 11D is a schematic front view of another liner formed from peripherally bonded first and second panels according to a specific embodiment, with the first panel having a zig-zag shaped localized region that imparts the first panel with collapse characteristics differing from the second panel.

FIG. 11E is a schematic front view of another liner formed from peripherally bonded first and second panels according to a specific embodiment, with the first panel having a rectangular localized region that imparts the first panel with collapse characteristics differing from the second panel.

FIG. 12 is a graph of calculated flow rate (in milliliters per minute) versus viscosity (in centipoise) for flow of fluids having three different viscosities (i.e., 1, 10, and 31 cps) through a 1 millimeter orifice at a pressure of 100 kpa.

### DETAILED DESCRIPTION OF THE INVENTION

The present invention relates to dispensing systems for the supply of fluid materials, and to methods of fabrication and use of such systems. In a specific aspect, the invention relates to a liner-based liquid containment systems for storage and dispensing of chemical reagents and compositions, e.g., high purity liquid reagents and chemical mechanical polishing compositions used in the manufacture of microelectronic device products.

In the use of liner-based packages for storage and dispensing of fluid materials, wherein the liner is mounted in a rigid or semi-rigid outer vessel, the dispensing operation may involve the flow of a pressure-dispense gas into the vessel, exteriorly of the liner, so that the pressure exerted by the gas forces the liner to progressively be compacted so that the fluid material in the liner in turn is forced to flow out of the liner. The thus-dispensed fluid material may be flowed to piping, manifolding, through connectors, valves, etc. to a locus of use, e.g., a fluid-utilizing process tool.

Such liner-based liquid containment systems can be employed for storage and dispensing of chemical reagents and compositions of widely varied character. Although the invention is hereafter described primarily with reference to storage and dispensing of liquid or liquid-containing compositions for use in the manufacture of microelectronic device products, it will be appreciated that the utility of the invention is not thus limited, but rather the invention extends to and encompasses a wide variety of other applications and contained materials.

The term “microelectronic device” as used herein refers to resist-coated semiconductor substrates, flat-panel displays, thin-film recording heads, microelectromechanical systems (MEMS), and other advanced microelectronic components. The microelectronic device may include patterned and/or blanketed silicon wafers, flat-panel display substrates or polymer substrates. Further, the microelectronic device may include mesoporous or microporous inorganic solids.

The liner-based liquid media containment systems of the present invention have particular utility in application to liquid media used in the manufacture of microelectronic device products. Additionally, such systems have utility in numerous other applications, including medical and pharmaceutical products, building and construction materials, food and beverage products, fossil fuels and oils, agriculture chemicals, etc., where liquid media or liquid materials require packaging.

A fluid dispensing package typically includes a dispensing port that is in communication with the liner for dispensing of material therefrom. The dispensing port in turn is coupled with a suitable dispensing assembly. The dispensing assembly can take any of a variety of forms, e.g., an assembly including a probe or connector with a dip tube that contacts material in the liner and through which material is dispensed from the vessel.

The dispensing assembly in one embodiment is adapted for coupling with flow circuitry, e.g., flow circuitry of a microelectronic device manufacturing facility using a chemical reagent supplied in the liner of the package. The semiconductor manufacturing reagent may be a photoresist or other high-purity chemical reagent or specialty reagent.

The package can be a large-scale package, wherein the liner has a capacity in a range of from 1 to 2000 or more liters of material.

In a pressure-dispense mode, the liner-based package can be adapted for coupling with a pressurized gas source, such as a pump, compressor, a compressed gas tank, etc.

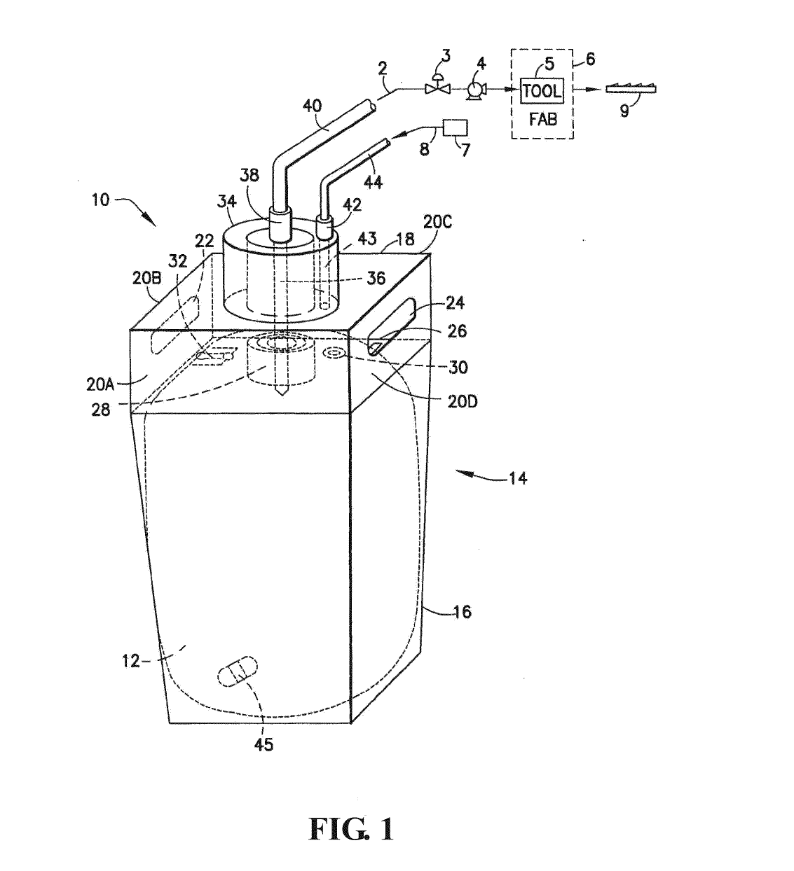

Referring now to the drawings, FIG. 1 is a schematic view of a process installation including a liner-based fluid storage and dispensing package arranged to provide a chemical reagent to a tool in a microelectronic product manufacturing facility, for the manufacture of a microelectronic product.

FIG. 1 shows a perspective view of an illustrative liner-based fluid storage and dispensing container 10 of a type useful in the broad practice of the present invention. The container 10 includes a flexible, resilient liner 12 capable of holding liquid, e.g., a high purity liquid (having a purity of >99.99% by weight).

In one embodiment, the liner 12 may be formed from at least two sheets of peripherally bonded (e.g., welded) polymeric film material. Such “two-dimensional” liner is susceptible to being expanded into a roughly cylindrical shape upon being filled with an appropriate fluid (e.g., liquid).

In another embodiment, the liner 12 may be formed from tubular stock material. By the use of a tubular stock, e.g., a blown tubular polymeric film material, heat seals and welded seams along the sides of the liner are avoided. In certain applications, the absence of side welded seams is advantageous, since the liner may be better able to withstand forces and pressures that tend to stress the liner and may, in extreme cases, lead to seam failure in peripherally bonded two-dimensional liners.

The liner 12 most preferably is a single-use, thin membrane liner, whereby it can be removed after each use (e.g., when the container is depleted of the liquid contained therein) and replaced with a new, pre-cleaned liner to enable the reuse of the overall container 10.

The liner 12 is preferably free of components such as plasticizers, antioxidants, UV stabilizers, fillers, etc. that may be or become a source of contaminants, e.g., by leaching into the liquid contained in the liner, or by decomposing to yield degradation products that have greater diffusivity in the liner and that migrate to the surface and solubilize or otherwise become contaminants of the liquid in the liner.

Preferably, a substantially pure film is utilized for the liner, such as virgin (additive-free) polyethylene film, virgin polytetrafluoroethylene (PTFE) film, or other suitable virgin polymeric material such as polyvinylalcohol, polypropylene, polyurethane, polyvinylidene chloride, polyvinylchloride, polyacetal, polystyrene, polyacrylonitrile, polybutylene, etc. More generally, the liner may be formed of laminates, co-extrusions, overmold extrusion, composites, copolymers and material blends, with or without metallization and foil.

The thickness of the liner material can be any suitable thickness, e.g., in a range from about 1 mils (0.001 inch) to about 30 mils (0.030 inch). In one embodiment, the liner has a thickness of 20 mils (0.020 inch).

The liner can be formed in any suitable manner such as peripheral bonding of thin sheets (as described hereinabove), or by tubular blow molding of a three-dimensional liner. An integral fill opening is preferably provided at an upper end of the vessel, which may, as shown in FIG. 1, be joined to a port or cap structure 28. The liner 12 thus may have an opening for coupling of the liner to a suitable connector for fill or dispense operations involving respective introduction or discharge of fluid. The cap joined to the liner port may be manually removable and may be variously configured, as regards the specific structure of the liner port and cap. The cap also may be arranged to couple with a dip tube for introduction or dispensing of fluid.

The liner 12 preferably includes two ports in the top portion thereof, as shown in FIG. 1, although single port liners, or alternatively liners having more than two ports, can be usefully employed in the broad practice of the present invention. The liner is disposed in a substantially rigid housing or overpack 14, which can be of a generally rectangular parallelepiped shape as illustrated, including a lower receptacle portion 16 for containing the liner 12 therein, and optionally an upper stacking and transport handling section 18. The overpack 14 is substantially more rigid in character than the liner 12. The stacking and transport handling section 18 includes opposedly facing front and rear walls 20A and 20C, respectively, and opposedly facing side walls 20B and 20D. At least two of the opposedly facing side walls (shown in FIG. 1 as 20B and 20D) have respective manual handling openings 22 and 24, respectively, to enable the container to be manually grasped, and physically lifted or otherwise transported in use of the container. Alternatively, the overpack can be of a cylindrical form, or of any other suitable shape or conformation.

In one embodiment, the lower receptacle portion 16 of the housing 14 is slightly tapered, as shown in FIG. 1. As illustrated, all of the four walls of the lower receptacle portion 16 are downwardly inwardly tapered, to enable the stacking of the containers for storage and transport, when a multiplicity of such containers are stored and transported. In one embodiment, the lower portion 16 of housing 14 may have tapered walls whose taper angle is less than 15°, e.g., an angle between about 2° and 12°.

The generally rigid housing 14 also includes an overpack lid 26, which is leak-tightly joined to the walls of the housing 14, to bound an interior space in the housing 14 containing the liner 12, as shown. A space between the liner 12 and the housing 14 is subject to pressurization to effectuate pressure dispensing of fluid contents of the liner 12.

In the apparatus illustrated in FIG. 1, the liner 12 has two rigid ports, including a main top port coupling to the cap 28 and arranged to accommodate passage therethrough of the dip tube 36 for dispensing of liquid. The dip tube 36 is part of the dispensing assembly including the dip tube, dispensing head 34, coupling 38 and liquid dispensing tube 40. The dispensing assembly also includes a gas fill tube 44 joined to dispensing head 34 by coupling 42 and communicating with a passage 43 in the dispensing head. Passage 43 in turn is adapted to be leak-tightly coupled to the interior volume port 30 (e.g., gas inlet port 30) in the overpack lid 26, to accommodate introduction of a pressurized gas for exerting pressure against liner 12 in the dispensing operation, so that liquid contained in liner 12 is forced from the liner through the interior passage of the hollow dip tube 36 and through the dispensing assembly to the liquid dispensing tube 40. The gas inlet port 30 is thus operatively coupled to receive pressurized gas from an external pressurized gas source (not shown) and deliver pressurized gas to a space between the overpack container and the liner for dispensation of the contents of the liner.

The gas fill tube 44 is joined to a gas feed line 8 coupled to a compressed gas source 7, e.g., a compressor, compressed gas tank, etc., for delivery of pressurizing gas into the interior volume of the overpack, and progressive compaction of the liner during the pressure dispense operation.

The liquid dispensing tube 40 is coupled with dispensed gas feed line 2 containing flow control valve 3 and pump 4 therein, to effect flow of the dispensed liquid from the package through such flow circuitry to the tool 5 (“TOOL”) in the microelectronic product manufacturing facility 6 (“FAB”). The tool 5 can for example comprise a spin coater for applying photoresist to a wafer, with the dispensed liquid constituting a suitable photoresist material for such purpose. The tool alternatively can be of any suitable type, which is adapted for utilizing the specific dispensed chemical reagent.

Liquid chemical reagents can therefore be dispensed for use in the microelectronic product manufacturing facility 6, from liner-based package(s) of the illustrated type, to yield a microelectronic product 9, e.g., a flat panel display or a semiconductor wafer incorporating integrated circuitry.

The liner 12 advantageously is formed of a film material of appropriate thickness to be flexible and collapsible in character. In one embodiment, the liner is compressible to about 10% or less of the rated fill volume, i.e., the volume of liquid able to be contained in the liner when same is fully filled in the housing 14. In various embodiments, the liner may be compressible to about 0.25% or less of rated fill volume, e.g., less than 10 milliliters in a 4000 milliliter package, or about 0.05% or less (10 mL or less remaining in a 19 L package), or 0.005% or less (10 mL or less remaining in a 200 L package). Preferred liner materials are sufficiently pliable to allow for folding or compressing of the liner during shipment as a replacement unit. The liner preferably is of a composition and character that is resistant to particle and microbubble formation when liquid is contained in the liner, that is sufficient flexible to allow the liquid to expand and contract due to temperature and pressure changes and that is effective to maintain purity for the specific end use application in which the liquid is to be employed, e.g., in semiconductor manufacturing or other high purity-critical liquid supply application.

For semiconductor manufacturing applications, the liquid contained in the liner 12 of the container 10 should have less than 75 particles/milliliter of particles having a diameter of 0.25 microns, at the point of fill of the liner, and the liner should have less than 30 parts per billion total organic carbon (TOC) in the liquid, with less than 10 parts per trillion metal extractable levels per critical elements, such as calcium, cobalt, copper, chromium, iron, molybdenum, manganese, sodium, nickel, and tungsten, and with less than 150 parts per trillion iron and copper extractable levels per element for liner containment of hydrogen fluoride, hydrogen peroxide and ammonium hydroxide, consistent with the specifications set out in the Semiconductor Industry Association, International Technology Roadmap for Semiconductors (SIA, ITRS) 1999 Edition.

The liner 12 of FIG. 1 may optionally contain in its interior space a metal pellet 45, as illustrated, to aid in non-invasive magnetic stirring of the liquid contents. The magnetic stirring pellet 45 may be of a conventional type as used in laboratory operations, and can be utilized with an appropriate magnetic field-exerting table, so that the container is able, when reposed on the table with the liner filled with liquid, to be stirred, to render the liquid homogeneous and resistant to settling. Such magnetic stirring capability may be employed to resolubilize components of the liquid subsequent to transit of the liquid under conditions promoting precipitation or phase separation of the liquid contents. The stirring element being remotely actuatable in such manner has the advantage that no invasive introduction of a mixer to the interior of the sealed liner is necessary.

The port 30 in deck 26 of the housing 14 can be coupled with a rigid port on the liner, so that the liner is fabricated with two ports, or alternatively the liner can be fabricated so that it is ventable using a single port configuration. In still another embodiment, a headspace gas removal port fitting surrounds the inner liquid dispense fitment without the use of an additional vent.

Deck 26 of the housing 14 may be formed of a same generally rigid material as the remaining structural components of the housing, such as polyethylene, polytetrafluoroethylene, polypropylene, polyurethane, polyvinylidene chloride, polyvinylchloride, polyacetal, polystyrene, polyacrylonitrile, and polybutylene.

As a further optional modification of the container 10, a radio frequency identification tag 32 may be provided on the liner, for the purpose of providing information relating to the contained liquid and/or its intended usage. The radio frequency identification tag can be arranged to provide information via a radio frequency transponder and receiver to a user or technician who can thereby ascertain the condition of the liquid in the container, its identity, source, age, intended use location and process, etc. In lieu of a radio frequency identification device, other information storage may be employed which is readable, and/or transmittable, by remote sensor, such as a hand-held scanner, computer equipped with a receiver, etc.

In the dispensing operation involving the container 10 shown in FIG. 1, air or other gas (nitrogen, argon, etc.) may be introduced into tube 44 and through port 30 of lid 26, to exert pressure on the exterior surface of the liner 12, causing it to contract and thereby forcing liquid through the dip tube 36 and dispensing assembly to the liquid dispensing tube 40.

Correspondingly, air may be displaced from the interior volume of housing 14 through port 30, for flow through the passage 43 in dispensing head 34 to tube 44 during the filling operation, so that air is displaced as the liner 12 expands during liquid filling thereof.

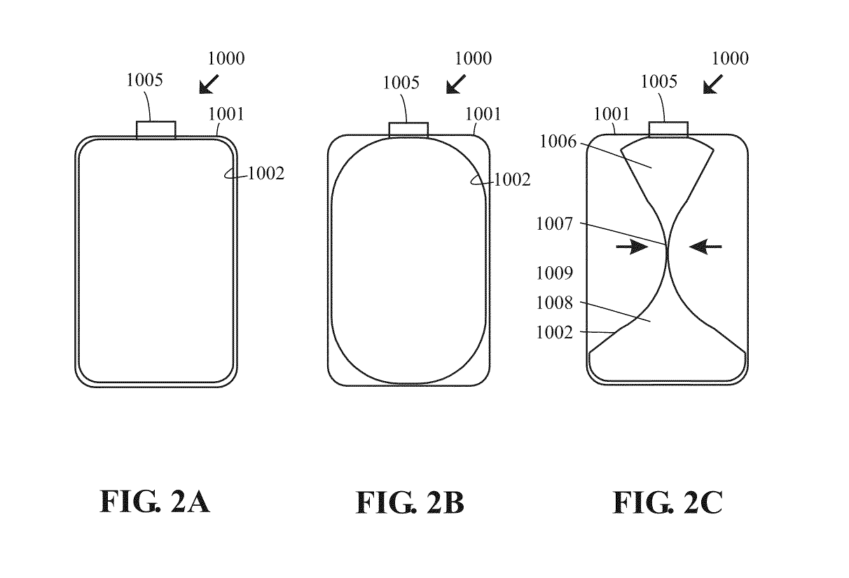

As mentioned previously, a problem associated with pressure dispensing of fluids fro collapsible liners is premature choke-off, when a liner prematurely necks and ultimately collapses on itself or a structure internal to the liner to form a choke point disposed above a substantial volume of fluid remaining to be dispensed. Such a problem is illustrated schematically in FIGS. 2A-2C. FIG. 2A shows a pressure dispense package 1000 including a liner 1002 equipped with a fitment 1005 disposed substantially within a rigid overpack 1001, prior to application of a significant pressure differential to compress the liner 1002. FIG. 2B shows the package 1000 as the interstitial space between the liner 1002 and overpack is pressurized 1001, with the liner 1002 being slightly compressed. FIG. 2C shows the package 1000 in an undesirable prematurely choked-off condition, with a central portion of the liner 1007 compressed to touch itself and close any pathway for fluid disposed in the lower portion 1008 of the liner 1002 to escape. An upper portion 1006 of the liner 1002 may remain open as well due to the presence of the rigid fitment 1005. Clearly, such choke-off phenomenon can be problematic, since it inhibits complete utilization of the chemical contents of the liner.

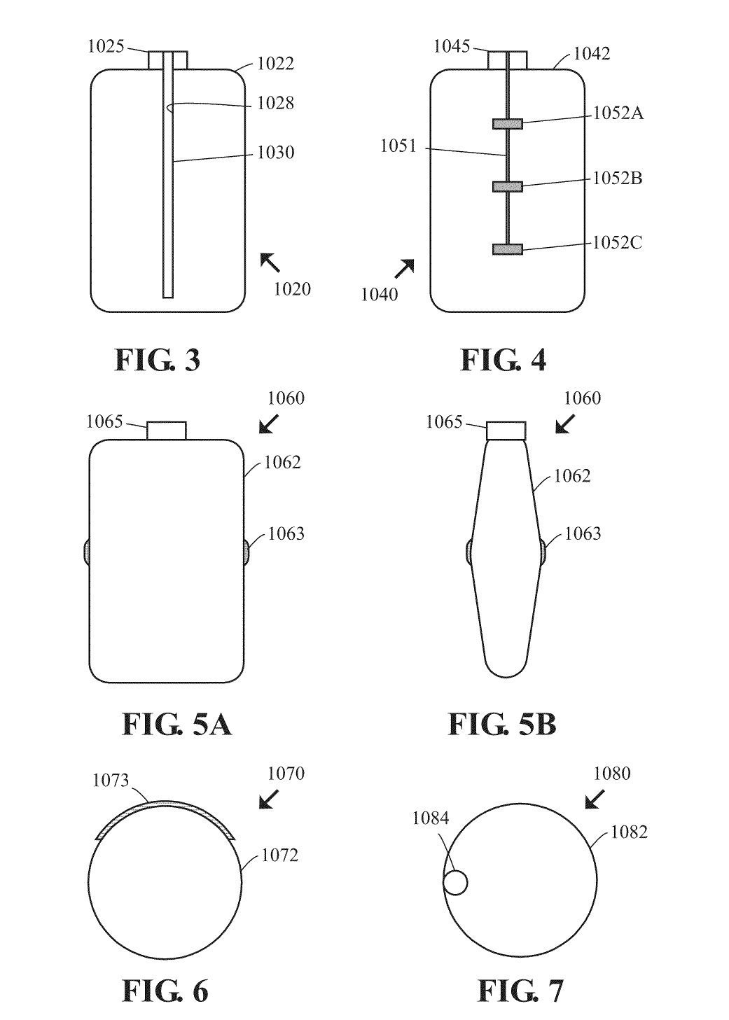

Various structures capable of ameliorating this choke-off problem are illustrated in FIGS. 3-8B.

FIG. 3 illustrates a pressure dispense package 1020 including a liner 1022 equipped with a fitment 1025, and having an internal hollow dip tube 1030. The dip tube 1030 may be perforated at multiple levels, or the dip tube 1030 may include a vertical or spiral channel along at least a portion of the exterior thereof to avoid liner collapse. Whereas a typical dip tube has an aperture at the lower or distal end thereof that serves as the only point of fluid egress from a liner, a so-called “dummy” dip tube used for preventing choke-off according to one embodiment optionally defines at least one other aperture or opening 1028, preferably at a top or intermediate portion along the dip tube, to permit fluid to be directed to a separate fluid extraction port (not shown). Such a separate fluid extraction port (not shown) may be provided in a liner and not connected to a dip tube used for choke-off prevention, with the dip tube defining a lower orifice and an upper orifice to prevent choke-off, and with the separate fluid extraction port positioned to withdraw fluid from an upper portion of the liner. In this regard, the extraction port may receive fluid directly from an upper portion of the liner, and further may receive fluid via the dip tube (through an upper orifice thereof) from a lower portion of the liner if the liner should collapse around an intermediate portion of the dip tube. A further benefit of an upper orifice 1028 defined in a dip tube is that such upper orifice 1028 may be used for headspace removal (i.e., removal of gas at the top of the package) at the beginning of the dispense cycle.

Although FIG. 3 illustrates a portion of a pressure dispense package having a dip tube, pressure dispense packages according to various embodiments described herein are preferably devoid of any dip tube.

FIG. 4 illustrates a pressure dispense package 1040 providing an alternative to using a hollow dip tube, in which a narrow rod 1051 having multiple perforated or channel-defining flanges 1052A-1052C suspended thereon is inserted into a liner 1042 equipped with a fitment 1045. Each flange 1052A-1052C preferably defines (e.g., vertically oriented) holes or surface channels therein or thereon to provide fluid flow paths toward to the top of the liner 1042 even if the liner 1042 should contract around the flanges 1052A-1052C. One advantage of using a rod 1051 and flanges 1052A-1052C is that the larger average diameter of a dip tube can be avoided, thus potentially enabling more contents of the liner 1042 to be extracted via pressure dispensation.

FIGS. 5A-5B illustrate a liner 1062 of a pressure dispense package 1060, with the liner 1062 having a first external radial stiffening element 1063 adapted to prevent intermediate liner collapse and a choke-off condition during pressure dispensation according to a specific embodiment. FIG. 5A illustrates the liner in a fully expanded state, and FIG. 5B illustrates the liner in a partially compressed state to showing the effect of the stiffening element to prevent intermediate liner collapse. A stiffening element may be fitted to the interior or (more preferably) the exterior of a liner 1062, or may alternatively be formed within the liner (e.g., laminated or otherwise positioned between multiple layers of liner material). The stiffening element 1063 may be elastic or compressible in nature, but is less collapsible than the liner 1062, which is preferably constructed from a polymeric film. The stiffening element 1063 may be a section or ring of a polymeric material coupled (e.g., by welding, adhesion, lamination, etc.) to one or more walls of the liner 1062. In one embodiment, the stiffening element 1063 is spiral or partially spiral in shape. The stiffening element preferably extends only a portion up the height of the liner 1062, positioned at or near a zone of otherwise potentially likely choke off.

FIG. 6 illustrates a top cross-sectional view of a liner 1072 of a pressure dispense apparatus 1070, the liner 1072 having an external stiffening element 1073 adapted to prevent intermediate liner collapse and a choke-off condition during pressure dispensation according to a specific embodiment. Notably, the stiffening element 1073 extends only a portion around the perimeter of the liner 1070. Such configuration permits the stiffening element 1073 (if short enough in height) to be more readily inserted through the aperture of an associated overpack container (not shown), and further permits the liner to achieve nearly full expulsion of its fluid contents at the end of a dispensing operation. If desired, the stiffening element 1073 may be coupled internal to the liner, external to the liner, or between layers of the liner. “Coupling” in this regard (and as used further herein) refers to non-specific attachment to, or, or in the liner, or formation as an integral part of the liner (e.g., via sealing, adhesion, or lamination with one or more layers of the liner).

FIG. 7 illustrates a top cross-sectional view of a liner 1082 of a pressure dispense apparatus 1080, the liner 1082 having an internal hollow support 1084 operatively coupled to an internal wall of the liner 1082. Such coupling in this instance may include direct coupling (e.g., attachment to an interior wall of the liner) or indirect coupling with one or more intermediate elements such as at least one collapsible support strip or support string affixed to a side wall of the liner. The hollow support 1084 preferably spans only a limited distance within the liner, proximate to a zone of otherwise potentially likely choke off. Such hollow support 1084 may be much shorter than a comparable dip tube supported from one end of the liner 1082, since it may be attached to and supported by the liner wall, and it may positioned only in a zone of otherwise potentially likely choke off. As compared to using a long hollow support (similar to a “dummy” tip tube as described hereinabove), the advantage of using a short hollow support is that it does not interfere so much with collapse of the liner, and thus does not greatly impede dispensation of fluid from the liner. Such hollow support may be attached to an internal wall of the liner by thermal welding or other joining techniques suitable for use with polymers. If desired to place a hollow support away from the wall (i.e., closer to the center of a liner), one or more collapsible intermediate supports may be provided between the hollow support and one or more walls of the liner. For example, one or more strips of polymeric film material (not shown) or strings may be welded to opposing interior surfaces or seams of the liner wall(s), with a hollow interior support centrally affixed to the support strip(s) or support string(s) to maintain the hollow support centrally within the interior of the liner when the liner is in an expanded (filled) state, with such support strip(s) or string(s) being collapsible against the hollow interior support as the liner contracts to an empty state. In this manner, a relatively short hollow interior support may be centrally supported within a liner to prevent choke-off, but the liner remains nearly fully collapsible onto itself in all other areas apart from the hollow interior support. “Relatively short” as used in connection with the hollow interior support in one embodiment means that the length of the hollow interior support is preferably less than or equal to about half the height of the liner, more preferably less than or equal to about one-fourth the height of the liner, and still more preferably less than or equal to about one-tenth the height of the liner.

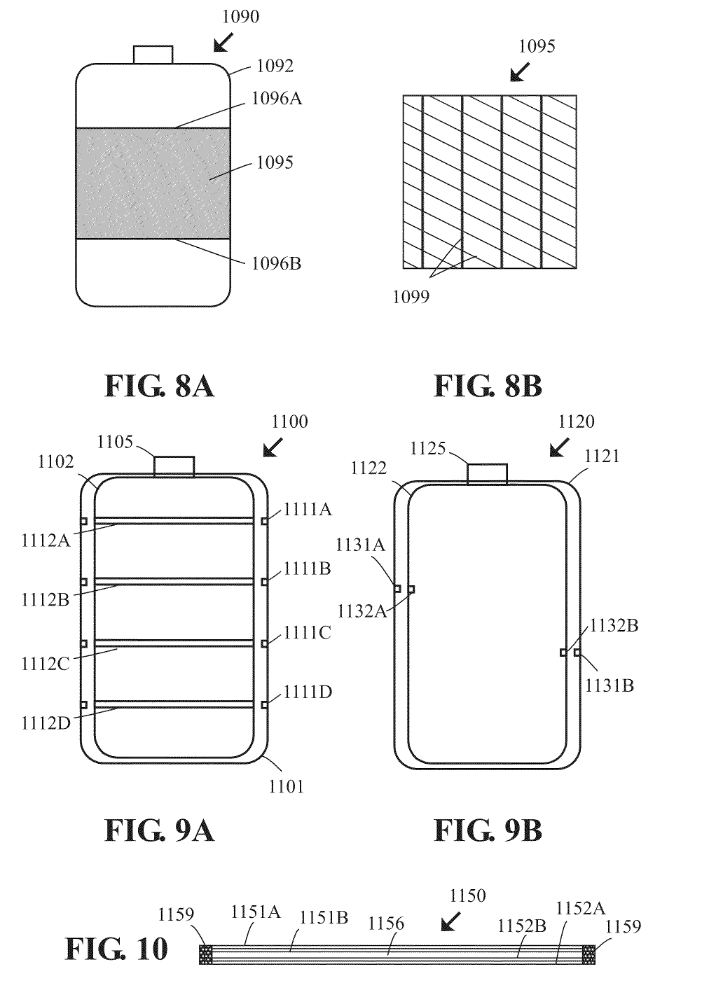

FIG. 8A is a schematic side cross-sectional view of a liner 1092 of a pressure dispense apparatus 1090, the liner 1092 comprising a film portion 1095 defining at least one liquid channel 1099 (see FIG. 8B) disposed along an internal surface of the liner 1092 and adapted to prevent intermediate liner collapse and a choke-off condition during pressure dispensation according to a specific embodiment. Such liquid channel(s) may be defined in a surface of the material by embossing or any other suitable technique. The film portion 1095 may be used to construct the entire liner 1092, or may be used for only a portion of the liner 1092 and joined to other materials via weld seams 1096A-1096B or other attachment means. Referring to FIG. 8B, channels may be defined in one or many directions in the film 1095. The presence of such channels provides a fluid flow pathway in case the liner should collapse upon itself.

FIGS. 9A-9B illustrate embodiments that utilize magnetic interaction to inhibit liner choke-off. FIG. 9A illustrates a package 1100 including a liner 1102 disposed within a container 1101 according to one embodiment. The liner 1102 is preferably surrounded in the container 1101. The liner 1102 includes an aperture-defining fitment 1105 adapted to be registered with an opening (not shown) defined in the container 1101 to enable fluid communication with the liner, such as to add material to the liner 1102 or dispense material therefrom. The liner 1102 includes choke prevention elements 1112A-1112D comprising magnetic or magnetically interactive elements (e.g., arranged as rings), with the container having corresponding magnetic or magnetically interactive elements 1111A-1111D adapted to magnetically interact with the choke prevention elements 1112A-1112D. In one embodiment, at least one magnetic material is coupled to the liner 1102 (e.g., disposed outside the liner, disposed between layers of one or more multi-layer liner panels, or, less preferably, disposed inside liner), with at least one magnetically interactive (e.g., ferrous) material arranged in or on a wall of the overpack container 1101. In another embodiment, at least one magnetically interactive material is associated with the liner 1102, and at least one magnetic material is correspondingly associated with the overpack container 1101. Any of the magnetic and/or magnetically interactive materials may be provided in any convenient form, such as discrete solid elements, flexible strips, tapes (e.g., with a pressure-sensitive adhesive surface), films, foils, or the like. Such elements may be oriented as rings if desired, but such orientation is not required. Any suitable type of magnetic or magnetically interactive materials may be used. In one embodiment, rare earth (e.g., neodymium) magnets are used, and preferably associated with a reusable overpack container. Magnetic elements (e.g., as associated with a container) may comprise one or more electromagnet to provide control of the applied magnetic field.

In the embodiment shown in FIG. 9B, a smaller number of discrete magnetic and magnetically interactive materials are provided. As few as one magnet and magnetically interactive material may be provided. A package 1120 includes a liner 1122 disposed within a container 1121, with the liner 1122 including an aperture-defining fitment 1125 adapted to be registered with an opening (not shown) defined in the container 1121. The liner 1122 includes choke prevention elements 1132A-1132B comprising magnetic or magnetically interactive elements (e.g., arranged as discrete elements), with the container 1121 having corresponding magnetic or magnetically interactive elements 1131A-1131B adapted to magnetically interact with the choke prevention elements 1132A-1132B.

Various liners have been described hereinabove. In various embodiments, liners may be formed from peripherally bonded panels. FIG. 10 shows a liner 1150 formed from a first panel composed of first sheet 1151A and second sheet 1151B, and a second panel composed of first sheet 1152A and second sheet 1152B, wherein the first and second panels 1151-1152 are peripherally bonded along a seal 1159. The sheets or layers of each panel may be laminated together along substantially the entire facial surfaces thereof, or the sheets may be allowed to move relative to one another without facial bonding therebetween. In further embodiments, unilayer panels are bonded together.

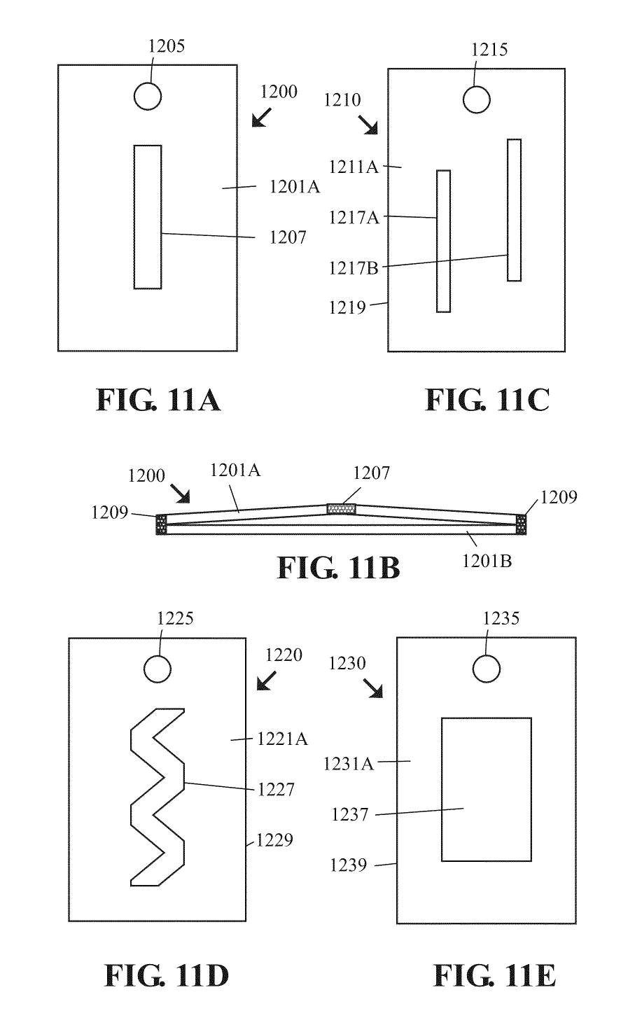

FIGS. 11A-11E show embodiments in which a choke prevention element includes a first panel of a liner having collapse characteristics differing from a second panel of the liner that is peripherally bonded to the first panel. Differing collapse characteristics between the two panels preserve a gap between the panels during pressure dispensing to prevent liner choke-off, as shown in FIG. 11B. It is to be understood that such differing collapse characteristics are experienced when a liner is subject to pressure dispensing, with the fitment of a liner registered within an overpack container, and with pressure applied to a space between the liner and container to compress the liner. Accordingly, the presence of a fitment along one panel or another of a liner fails to affect collapse characteristics of one panel relative to the other, as such fitment is supported above, and disposed away from, any potential choke-off region along the liner.

Differing collapse characteristics may be obtained by various methods, including localized or bulk processes, such as: thermal processing, thermal and pressure processing, addition of layers of the same or differing composition from a bulk layer (whether localized or across an entire panel), and the like. Preferred thermal processing includes heat sealing and welding. In one embodiment, at least a portion of the first panel is compositionally different from the second panel. In another embodiment, at least a portion of the first panel is thicker than the second panel. In one embodiment, the first panel comprises a peripheral edge circumscribing a first panel face, and at least a portion of the first panel face is thermally modified to impart the first panel with collapse characteristics differing from the second panel. In one embodiment, the entire first panel is treated or processed to impart differing collapse characteristics relative to the second panel. In one embodiment, the first panel comprises a peripheral edge circumscribing a first panel face, and at least a portion of the first panel face is modified by application of heat and pressure to impart the first panel with collapse characteristics differing from the second panel. In one embodiment, a liner includes a stiffening material disposed in or on the first panel and adapted to inhibit collapse of the first panel against the second panel. The effect of various modifications to the first panel as described herein is to form a stiffened region along such panel relative to the second panel.

FIG. 11A shows a liner 1200 having a fitment 1205 and a peripheral seal 1209 between layers 1201A-1201B. The first panel 1207 includes a locally treated region 1207 to impart differential collapse characteristics between the first and second panels. Such locally treated region 1207 may be formed, for example, via thermal processing with a heat sealer. Such thermal processing may include locally elevating temperature of the first panel to a melting temperature range a material with which the panel is formed. FIG. 11B shows a cross-sectional view of the liner of FIG. 11A, wherein collapse of the first panel 1201A is inhibited to a degree by the element 1207.

FIG. 11C shows a liner 1210 having a fitment 1215, front panel 1211A, peripheral seal 1219, and multiple locally treated regions 1217A-1217B arranged vertically. FIG. 11D shows a similar liner 1220 having a fitment 1225, front panel 1221A, peripheral seal 1229, and treated region 1227 arranged in a zig-zag conformation. FIG. 11E shows a liner 1230 having a fitment 1235, front panel 1231A, peripheral seal 1239, and large rectangular treated region 1237. Such region may 1237 be locally treated (e.g., with pressure or temperature), or such region 1237 may comprise additional material (e.g., adhered to, thermally bonded to, or laminated within various layers of, the front panel 1231A). In each case, different collapse characteristics are imparted to the first panel relative to a second panel to inhibit liner choke-off.

Treatment of a first panel to impart different collapse relative to a second panel of a liner is preferably performed prior to peripheral bonding between the first panel and second panel.

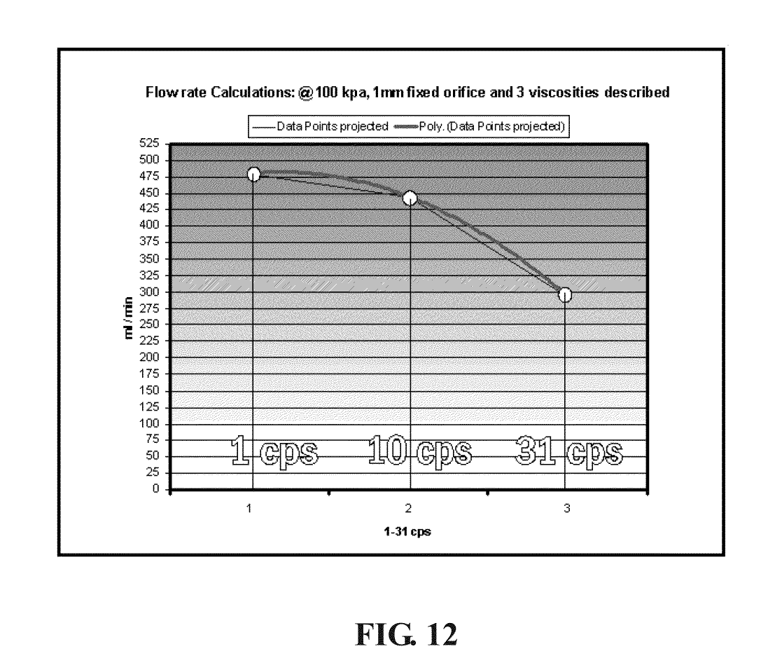

The effect of even a very small pathway (e.g., 1 millimeter diameter orifice) in maintaining flow is illustrated in FIG. 12, which provides a graph of calculated flow rate (in milliliters per minute) versus viscosity (in centipoise) for flow of fluids having three different viscosities (i.e., 1, 10, and 31 cps) through a 1 millimeter orifice at a pressure of 100 kpa. This demonstrates that even small channels can be effective in avoiding fully choked conditions over a variety of fluid viscosities.

Use of pressure dispense packages disposed in feed relationship with one or more fluid utilizing process tools (e.g., microelectronic device processing tools) is specifically contemplated. In one embodiment, a microelectronic device manufacturing facility includes a microelectronic device processing tool connected to receive liquid from a liner-based pressure dispense package having a choke prevention element as described hereinabove.

In addition to the forgoing structures adapted to prevent choke-off of a collapsible liner, methods for preventing choke-off are similarly contemplated. One method for preventing choke-off of a collapsible liner adapted for pressure dispensing includes adding a choke prevention element to said liner, the choke prevention element comprising any of: (a) at least one perforated flange disposed within the liner, (b)

at least one channel-defining flange disposed within the liner, (c) a film defining at least one liquid channel disposed along an internal surface of the liner, (d) a radial stiffening element coupled to the liner, (e) a hollow internal support disposed within and operatively coupled to a side wall of the liner, the hollow internal support having a first orifice disposed in a lower portion of the liner, and having a second orifice disposed in an upper portion of the liner, (f) at least one first magnetic or magnetically interactive material coupled to the liner, said at least one first magnetic or magnetically interactive material being adapted to interact with a corresponding at least one second magnetic or magnetically interactive material coupled to an overpack container surrounding the liner, and (g) a first panel of the liner having collapse characteristics differing from a second panel of the liner that is peripherally bonded to the first panel. Such liner is preferably disposed in an overpack container. The space between the liner and the overpack is then pressurized to dispense fluid from the liner, and the choke prevention element is utilized to prevent liner choke-off during said fluid dispensation. By preventing liner choke-off during fluid dispensation, undesirable “pocketing” of residual fluid in a lower portion of a liner not susceptible to dispensation is avoided.

While the invention has been has been described herein in reference to specific aspects, features and illustrative embodiments of the invention, it will be appreciated that the utility of the invention is not thus limited, but rather extends to and encompasses numerous other variations, modifications and alternative embodiments, as will suggest themselves to those of ordinary skill in the field of the present invention, based on the disclosure herein. Correspondingly, the invention as hereinafter claimed is intended to be broadly construed and interpreted, as including all such variations, modifications and alternative embodiments, within its spirit and scope.

### INDUSTRIAL APPLICABILITY

The present invention is useful in industry, as it promotes efficient delivery and usage of pressure dispensed chemical reagents to various fluid-utilizing processes.

What is claimed is:

1. A pressure dispense package comprising:
a collapsible liner adapted to hold a fluid; and
at least one choke prevention element comprising any of the following items (a) and (b):
(a) at least one perforated or channel-defining flange disposed within the liner; and
(b) a radial stiffening element coupled to the liner, the radial stiffening element being arranged along an intermediate portion of the liner.

2. The pressure dispense package of claim 1, being devoid of a dip tube or dispensing probe.

3. The pressure dispense package of claim 1, further comprising an overpack container formed of a material that is substantially more rigid than the liner, wherein the liner is disposed within the overpack container.

4. The pressure dispense package of claim 3, further comprising a gas inlet port arranged to deliver pressurized gas to a space between the overpack container and the liner.

5. The pressure dispense package of claim 1, comprising at least one perforated or channel-defining flange disposed within the liner.

6. The pressure dispense package of claim 5, wherein the at least one perforated or channel-defining flange defines at least one channel enabling flow of fluid from a lower portion of the liner to an upper portion of the liner.

7. The pressure dispense package of claim 5, wherein each flange of the at least one perforated or channel-defining flange comprises a width greater than a height of the flange.

8. The pressure dispense package of claim 5, wherein the at least one perforated or channel-defining flange comprises a plurality of perforated or channel-defining flanges defining a plurality of channels enabling flow of fluid from a lower portion of the liner to an upper portion of the liner.

9. The pressure dispense package of claim 1, comprising a radial stiffening element coupled to the liner, the radial stiffening element being arranged along an intermediate portion of the liner.

10. The pressure dispense package of claim 9, wherein the radial stiffening element extends around substantially an entire perimeter of the liner.

11. The pressure dispense package of claim 9, wherein the liner comprises a plurality of walls, and the radial stiffening element is affixed to multiple walls of the plurality of walls.

12. The pressure dispense package of claim 9, wherein the radial stiffening element comprises a spiral shape.

13. The pressure dispense package of claim 9, wherein the radial stiffening element is arranged along an external surface of the liner.

14. The pressure dispense package of claim 1, wherein the liner comprises a three-dimensional liner.

15. The pressure dispense package of claim 14, wherein the three-dimensional liner comprises blown tubular polymeric film that is devoid of welded seams along sides of the liner.

16. The pressure dispense package of claim 1, wherein top and bottom portions of the liner are devoid of any choke prevention element

17. The pressure dispense package of claim 1, connected in feed relationship to a fluid-utilizing process tool.

18. A microelectronic device manufacturing facility comprising a microelectronic device processing tool connected to receive liquid from the pressure dispense package of claim 17.

19. A method for preventing choke-off of a collapsible liner adapted for pressure dispensing of a fluid when the liner is disposed within an overpack container, the method comprising:
adding at least one choke prevention element to said liner, the at least one choke prevention element comprising any of the following items (a) and (b):
(a) at least one perforated or channel-defining flange disposed within the liner; and
(b) a radial stiffening element coupled to the liner, the radial stiffening element being arranged along an intermediate portion of the liner; and
inserting the liner into an overpack container, wherein the overpack container comprises a material that is substantially more rigid than the liner.

20. The method of claim 19, further comprising pressurizing a space between the liner and the overpack container to dispense fluid from the liner, and utilizing the choke prevention element to prevent liner choke-off during said fluid dispensation.
